(19) United States
(12) Patent Application Publication
(10) Pub. No.: US 2020/0184783 A1
(43) Pub. Date: Jun. 11, 2020

(54) EMERGENCY DOOR ALARM THAT PRODUCES A RAMPED OR STEPPED ALARM SIGNAL

(71) Applicant: Barry Glick, East Rutherford, NJ (US)

(72) Inventor: Barry Glick, East Rutherford, NJ (US)

(21) Appl. No.: 16/210,161

(22) Filed: Dec. 5, 2018

(51) Int. Cl. G08B 3/10; G08B 13/08; G08B 21/02; G08B 25/00; G08B 5/36

(52) U.S. Cl. CPC G08B 3/10; G08B 13/08; G08B 5/36; G08B 25/008; G08B 21/02

(57) ABSTRACT

Methods and apparatus (systems) are set forth for generating a ramping output alarm signal. An input alarm driver signal is used to generate a ramp control signal over a predetermined time period, t. A first predetermined output alarm signal is generated at the beginning of time period t; ramping to a second predetermined output alarm signal at the end of time period t, in response to the ramp control signal. Output alarm signals contemplated by the invention may also be stepped (as opposed to ramped), signals. In addition, both audio and visual alarm signals are contemplated by the invention. Both ramping and stepped output alarm signals would, for example, find particular utility in door alarms used in environments where sensitivity to the alarm signal itself is or may be an issue. Such environments include, without limitation, nursing homes and cardiac rehab facilities.

### BACKGROUND OF THE INVENTION

### 1. Field of the Invention

The invention relates generally to door alarms. More particularly, the invention relates to door alarms which may be advantageously used in environments where sensitivity to the alarm signals themselves is (or may be) an issue.

In accordance with one aspect of the invention a door alarm is described which produces a ramped audio alarm signal when the alarm is tripped. The ramped audio alarm signal is initiated at the beginning of a time period t over which the alarm is sounded, at a first volume level of x decibels. The signal ramps up to a volume of y decibels at the end the time period over which the alarm is sounded, where y is greater than x.

According to a further aspect of the invention a door alarm is described which produces a stepped audio alarm signal when the alarm is tripped. The stepped audio alarm signal is initiated at the beginning of a time period t over which the alarm is sounded, at a first volume level of x decibels. The alarm signal is stepped up to a volume of y decibels at the end of the period over which the alarm is sounded, where y is greater than x.

According to further aspects of the invention, door alarms are described which produce ramped and/or stepped visual alarm signals, increasing in brightness over the period over which the alarm is given.

Once again, the described door alarms are particularly well suited for use in the aforementioned environments where sensitivity to the alarm signals themselves is (or may be) an issue. Thus, for example, rather than sounding a piercing audio alarm in a nursing home or cardiac rehab facility that unduly frightens or shocks residents when an armed door is purposely or accidently opened; an alarm ramping or being stepped from a predetermined volume not apt to cause angst, to a more typical alarm volume, is contemplated by aspects of the described invention.

### 2. Description of the Prior Art

Door alarms and door security systems are well known in the prior art. Illustrative examples of commercially available door alarms include those manufactured by Vimpex Limited (of Essex England), General Electric Company (GE), Safety Technology International (STI), Jane's Senior Products and Rodann Electronics, to name but a few.

One such device, the “EXIT STOPPER” manufactured by Vimpex, is marketed as emitting “an ear-piercing alarm” (emphasis added), once a protected door is opened. Factory settings for volume are, High Volume* (97 dB); and Low Volume (95 dB). For obvious reasons an “ear piercing alarm” would not be suitable for use in environments where sensitivity to the alarm signal itself is (or may be) an issue.

The Vimpex Exit Stopper also teaches and is illustrative of a door alarm that includes: a key operated override facility to silence the alarm and allow authorized exits; is fitted with a 9V PP3 alkaline battery to power the device, may be mounted or installed on almost any type of door and has 32 user programmable features. The programmable features include alarm duration, alarm volume, an alarm trip delay and an arming feature.

Another device illustrative of the prior art is the GE door alarm marketed as the “GE Deluxe Wireless Door Alarm”. The GE device features a 120 db Alarm, an “Alarm” or “Entry Chime” mode of operation, and an Indoor Personal Security feature, with Keypad Activation.

The GE 120 decibel alarm is marketed as being “ . . . perfect for homes, apartments, dorm rooms and offices. [The]120 decibel alarm is loud enough to make a would-be intruder think twice about entering through your door and alert your neighbors of a possible break-in.” (emphasis added).

Yet another type of alarm device illustrative of the prior art, are door alarms that are specifically marketed for seniors and Alzheimer's patients. The “Door Alarms for Senior Safety”, by Jane's Senior Products in partnership with “Puzzle with Me”, address many of the challenges of taking care of seniors and Alzheimer's patients, where safety is always a high priority. While personal monitoring around the clock might seem impossible, alarms are taught for helping to keep a family member safe 24 hours of the day, seven days of the week. This type of door alarm is particularly useful in preventing/detecting Alzheimer's wandering.

In particular, Jane's teaches a motion detector with remote alarm to keep track of a loved one's movements. The remote alarm comes with a high-performance transmitter and receiver set that can be customized to monitor a room or selected area, depending on individual requirements. The door alarm works in such a way that when a monitored door is opened the transmitter sends a signal to the receiver/alarm that monitors two, three or more doors, depending on the number of transmitters in the network. The device may be plugged into any standard AC wall outlet in, for example, a bedroom, kitchen, den, etc.

The device taught and sold by Jane's features three discrete alarm settings that allow flexibility in the alarm sounded (emphasis added).

A first setting, “CHIME”, sounds an electronic chime when a monitored door is opened, the chime is sounded but once, no more, in contrast to other prior art alarms which produce very loud alarms over an extended time period which might be distressing for seniors and Alzheimer's patients.

A second setting for the Jane's device, called “MELODY”, will cause a selected tune to be played once, no more; and will reset once the monitored door is closed. Various tunes may be selected for playing in MELODY mode.

Finally, in an “ALARM” mode, a warning will sound and continue to sound for four minutes or until it is turned off, even after the door is closed, much like other known door alarms.

The Jane's device/reference specifically teaches a door alarm which is adjustable to one of several alarm settings for use in an environment where noise sensitivity can be an issue. However, these devices do not provide an alarm which self adjusts from one predetermined first, relatively low, alarm signal to a second higher alarm signal; either linearly or in a stepped fashion, to help mitigate the affect of the actual alarm on those being alerted and/or protected.

Still other commercially available devices teach the use of adjustable alarm volume controls to sound an entry chime when an individual walks through a monitored zone. One such device, an entrance alarm chime manufactured by Rodann, provides an entry chime signal the volume of which may be adjusted whenever a PIR (passive infrared) sensor is tripped, indicating a person is walking through an entrance/monitored zone. One of four tones may be generated by the Rodann door alarm.

Finally, reference is made to a report published by James J. MacNeal, David C. Cone and Christopher L. Wistrom, entitled: “Effect of Station-Specific Alerting and Ramp-Up Tones On Firefighters' Alarm Time Heart Rates”, posted online on 12 May 2016 and published online 8 Sep. 2016 (pages 866-870), for its teachings of how stress and fatigue can be reduced in emergency responders by changing the method by which the responders (e.g., firefighters) are alerted to emergency situations.

According to MacNeal et al, over a period of several months, the method by which responders at a fire department were alerted was modified/altered.

Firefighter heart rates were measured first with standard alerting as a control (phase 1: all stations alerted simultaneously, with high-volume tones).

The department then implemented station-specific (phase 2) and gradual volume ramp-up (phase 3) tone alerting. Heart rate increases were then compared for this three-phase alerting methodology.

The Fatigue Severity Score was used to examine firefighter fatigue, and the department administered a follow-up survey on personnel preferences. The Fatigue Severity Scale showed little variability: median scores 7 in phase 1, 8 in phase 2, and 7 in phase 3. Firefighters reported a strong preference for the phase 3 “ramp-up” tones.

The MacNeal study concluded ramp-up tones were the best method to reduce emergency responder stress. The study also found that small but significant decreases in the amount of tachycardiac response to station alerting were associated with simple alterations in alerting methods. Again, ramp-up tones were perceived as the best alerting mechanism to reduce first responder stress.

Based on the state of the art of door alarms as exemplified by the commercially available door alarms cited hereinabove; and based on the study of MacNeal et al., regarding stress reduction in alarm situations where a ramp-up alarm was used to alert first responders to emergency situations, it would be desirable if a door alarm could be provided that incorporated a ramp-up alarm. Such an alarm could be advantageously used in environments where sensitivity to the alarm signals themselves is (or may be) an issue.

Similarly, it would be desirable if a door alarm could be provided that incorporated a stepped-up alarm, also for use in environments where sensitivity to the alarm signals themselves is (or may be) an issue.

Furthermore, it would be desirable if door alarms that provide ramped-up or stepped-up alarm signals, could provide either or both audio and visual alarm signals, for use in a multiplicity of “alarm type” sensitive environments.

### SUMMARY OF THE INVENTION

Thus, it is an object of the invention to provide a door alarm that could be advantageously used in environments where sensitivity to the alarm signals themselves is (or may be) an issue.

It is a further object of the invention to provide a door alarm that reduces stress on individuals being alerted to the alarm situation.

Furthermore, it is an object of the invention to provide a door alarm that incorporates a ramp-up alarm signal.

Further yet, it is an object of the invention to provide a door alarm that incorporates a step-up alarm signal.

Still further, it is an object of the invention to provide door alarms incorporating ramped-up and/or stepped-up alarm signals, that are either (or both) audio and/or visual alarm signals.

In accordance with one aspect of the invention a door alarm is described which produces a ramped audio alarm signal when the alarm is tripped. The ramped audio alarm signal is initiated at the beginning of a time period t over which the alarm is sounded, at a first volume level of x decibels. The signal ramps up to a volume of y decibels at the end the time period, where y is greater than x.

According to a further aspect of the invention a door alarm is described which produces a stepped audio alarm signal when the alarm is tripped. The stepped audio alarm signal is initiated at the beginning of a time period t over which the alarm is sounded, at a first volume level of x decibels. The alarm signal is stepped up to a volume of y decibels at the end of the period over which the alarm is sounded, where y is greater than x.

According to further aspects of the invention, door alarms are described which produce ramped and/or stepped visual alarm signals, increasing in brightness over the period over which the alarm is given.

Once again, the described door alarms are particularly well suited for use in the aforementioned environments where sensitivity to the alarm signals themselves is (or may be) an issue. Thus, for example, rather than sounding a piercing audio alarm in a nursing home or cardiac rehab facility that unduly frightens or shocks residents when an armed door is purposely or accidently opened; an alarm ramping from a predetermined volume not apt to cause angst, to a more typical alarm volume, is contemplated by one of the aspects of the invention described herein.

### BRIEF DESCRIPTION OF THE DRAWING

FIG. 1 is a block diagram depicting a door alarm that produces a ramping alarm signal over a predetermined time period t.

FIG. 2 is a block diagram depicting a door alarm that produces a stepped alarm signal over a predetermined time period t.

FIG. 3 is a flow chart depicting a method for generating a ramping alarm signal over a predetermined time period t.

FIG. 4 is a flow chart depicting a method for generating a stepped alarm signal over a predetermined time period t.

### DETAILED DESCRIPTION OF THE INVENTION

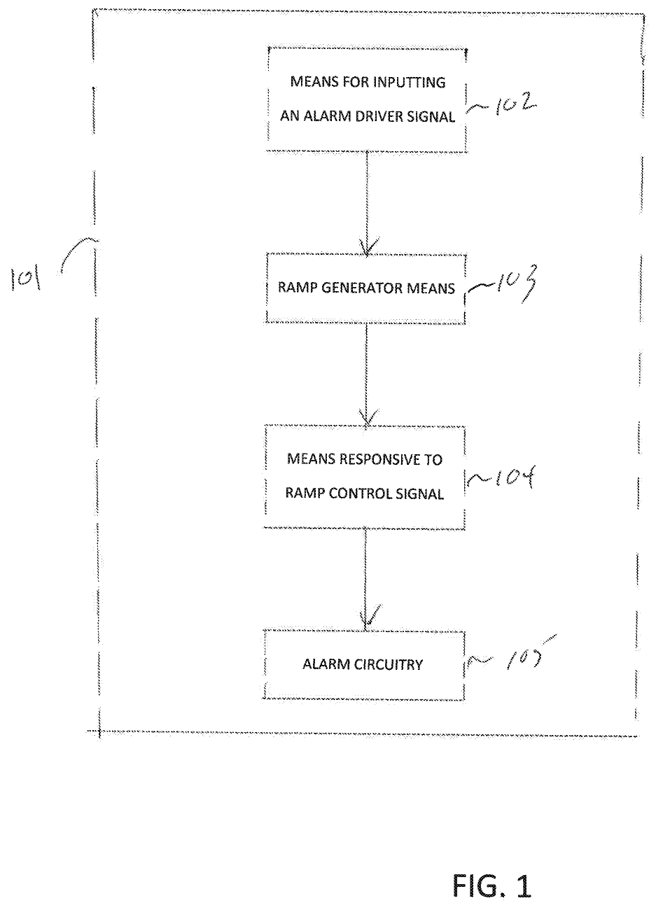

FIG. 1 is a block diagram depicting illustrative door alarm 101. In accordance with the teachings of one aspect of the invention, door alarm 101 produces a ramping alarm signal over a predetermined time period t.

In particular, in accord with a preferred embodiment of the invention, FIG. 1 depicts door alarm 101, comprising means 102, for inputting an alarm driver signal to the exemplary door alarm; ramp generator means 103, responsive to the alarm driver signal, for generating a ramp control signal; means 104, responsive to the ramp control signal to develop a first predetermined alarm signal at the beginning of a time period t, that ramps to a second predetermined alarm signal at the end of time period t; and alarm circuitry 105, responsive to the alarm signal ramping from the first predetermined alarm signal to the second predetermined alarm signal (produced by means 104), to sound an audible alarm ranging from x decibels at the beginning of time period t, to y decibels at the end of time period t, where y is greater than x.

A power source, such as a 9-volt battery, coupled to ramp generator means 103 of FIG. 1, may be used to provide an alarm driver signal output for ramp generator means 103, whenever the illustrative alarm is “tripped”. For the purposes of illustration only, door alarm 101; may be considered “tripped” when a door protected by the alarm is opened.

Alternatively, and by no means exclusively, stepped down AC house current may be used to drive illustrative door alarm 101.

Ramp generator means 103 may be realized by linear voltage ramp generator circuitry, well known by those skilled in the art as a circuit that creates a linear rising (or falling) output with respect to time. The variable is usually, though not necessarily, voltage.

The ramp control signal produced by depicted ramp generator means 103 may be used, according to a preferred embodiment of the invention, to drive means 104 (responsive to the ramp control signal), to develop a first predetermined alarm signal at the beginning of a time period t, that ramps to a second predetermined alarm signal at the end of time period t.

Alarm circuitry 105, according to the illustrative embodiment of door alarm 101 being described with reference to FIG. 1, is responsive to the alarm signal ramping from the first predetermined alarm signal to the second predetermined alarm signal (produced by means 104), to sound an audible alarm ranging from x decibels at the beginning of time period t, to y decibels at the end of time period t, where y is greater than x.

Those skilled in the art will readily appreciate that the alarm generated by alarm circuitry 105 need not necessarily be a ramped audible alarm. The alarm could, for example, be a visual alarm or display, ramping up in intensity over time period t.

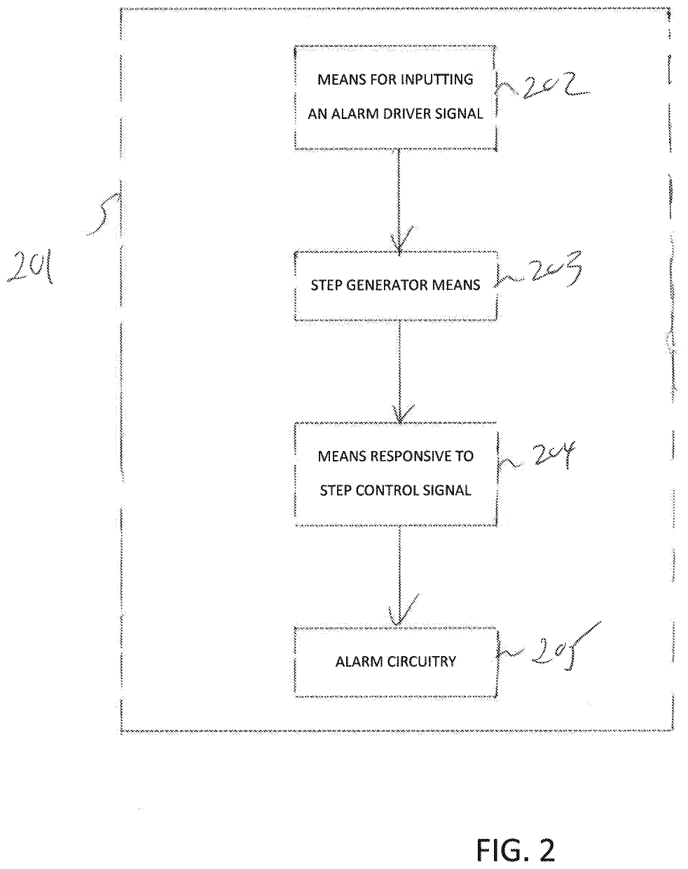

Turning now to FIG. 2, a block diagram is shown depicting illustrative door alarm 201. In accordance with the teachings of another aspect of the invention, door alarm 201 produces a stepped alarm signal over a predetermined time period t, having n subintervals (or steps), t₁ through tₙ.

FIG. 2 depicts door alarm 201 comprising means 202, for inputting an alarm driver signal to the exemplary door alarm; step generator means 203, responsive to the alarm driver signal, for generating a step control signal; means 204, responsive to the step control signal to develop a first predetermined alarm signal at the beginning of a time period t, that steps up over predetermined subintervals of t (t₁ . . . tₙ), to a second predetermined alarm signal at the end of time period t; and alarm circuitry 205, responsive to the alarm signal stepping up from the first predetermined alarm signal to the second predetermined alarm signal (produced by means 204), to sound an audible alarm ranging from x decibels at the beginning of time period t, and stepped up to y decibels at the end of time period t, where y is greater than x.

Step generator means 203 may be realized by utilizing a boost converter, well known to those of ordinary skill in the art, to perform stepped up DC to DC conversion. Step generator 203 may, for example, include a timer that at the end of each predetermined time interval t₁ though t, of predetermined time period t, generates a “stepped up” step control signal driving alarm 205.

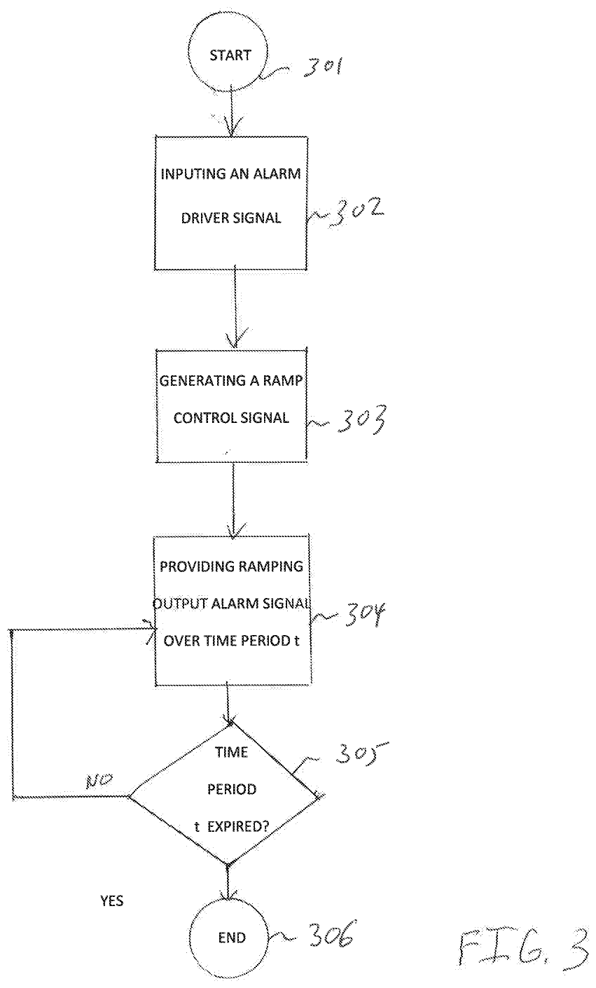

Turning now to FIG. 3, a flowchart depicting a method for generating a ramping alarm signal is illustrated. The process of flowchart FIG. 3 is depicted as starting at 301.

FIG. 3 next depicts step 302, which is the step of inputting an alarm driver signal; and generating, in response thereto, a ramp control signal at step 303. According to the invention, the ramp control signal is generated over a predetermined time period t. The ramp control signal, as indicated hereinbefore, may be generated utilizing linear voltage ramp circuitry well known to those of ordinary skill in the art.

Following step 303 in FIG. 3 is the step 304, which is the step of providing an output alarm signal over time period t. More particularly, according to a preferred embodiment of the invention, step 304 is executed by providing, in response to the ramp control signal, a first predetermined output alarm signal at the beginning of time period t, ramping to a second predetermined output alarm signal at the end of time period t.

Step 305 is performed in the illustrative embodiment of the invention being described with reference to FIG. 3, to determine if and when time period t expires, with the ramp output alarm signal continuing to ramp until time period t expires. Upon expiration of time period t, the process depicted in FIG. 3 is shown to end at 306.

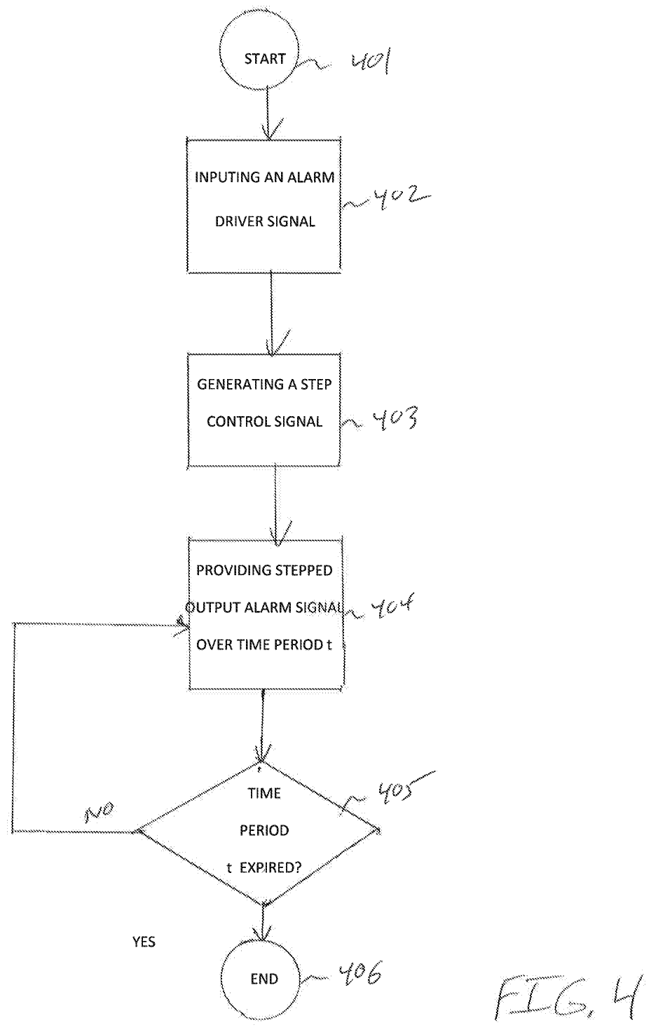

Turning finally to FIG. 4, a flowchart depicting a method for generating a stepped alarm signal is illustrated. The process of flowchart FIG. 4 is depicted as starting at 401.

FIG. 4 next depicts step 402, which is the step of inputting an alarm driver signal; and generating, in response thereto, a step control signal at process step 403. According to the invention, the step control signal is generated over a predetermined time period t. The step control signal, as indicated hereinbefore, may be generated utilizing a boost converter, well known to those of ordinary skill in the art, to perform stepped up DC to DC conversion.

Following step 403 in FIG. 4 is the step 404, which is the step of providing a stepped output alarm signal over time period t. More particularly, according to a preferred embodiment of the invention, step 404 is executed by providing, in response to the step control signal, a first predetermined output alarm signal at the beginning of time period t, stepping up to a second predetermined output alarm signal at the end of time period t.

According to an illustrative embodiment of the of the invention, the “step up” is performed over discrete predetermined subintervals of t (t₁ . . . tₙ), from the first predetermined output alarm signal at the beginning of time period t, stepping until reaching the second predetermined output alarm signal at the end of time period t.

Step 405 is performed in the illustrative embodiment of the invention being described with reference to FIG. 4, to determine if and when time period t expires, with the stepped output alarm signal continuing to “step up” until time period t expires. Upon expiration of time period t, the process depicted in FIG. 4 is shown to end at 406.

What has been described herein are methods and apparatus (systems) for generating a ramping output alarm signal over a predetermined time period, t.

A first predetermined output alarm signal is generated at the beginning of time period t; ramping to a second predetermined output alarm signal at the end of time period t, in response to the ramp control signal.

Output alarm signals contemplated by the invention may also be stepped (as opposed to ramped), signals.

In addition, both audio and visual alarm signals are contemplated by the invention.

Both ramping and stepped output alarm signals would, for example (as described in detail hereinbefore), find particular utility for door alarms used in environments where sensitivity to the alarm signal itself is or may be an issue. Such environments include, without limitation, nursing homes and cardiac rehab facilities.

While particular embodiments of the invention have been described, it is not intended that the invention be limited thereto, as it is intended that the invention be as broad in scope as the art will allow and that the specification be read likewise. For example, the “step up” and ramp described hereinabove, over a time period t, may not necessarily be either linear or always “up”. Thus, one could imagine an alarm signal that “oscillates” in tone over time as it achieves a maximum alarm output.

In addition, the visual alarm output contemplated by the invention may likewise “oscillate” over time period t; subintervals of t, t₁ thru tₙ, may vary in length; and even combinations of alarms (audio and visual) are contemplated by the invention.

While particular embodiments of the invention have been described, it is not intended that the invention be limited thereto, as it is intended that the invention be as broad in scope as the art will allow and that the specification be read likewise. For example, the “step up” and ramp described hereinabove, over a time period t, may not necessarily be either linear or always “up”. Thus, one could imagine an alarm signal that “oscillates” in tone over time as it achieves a maximum alarm output.

In addition, the visual alarm output contemplated by the invention may likewise “oscillate” over time period t; subintervals of t, t1 thru tn, may vary in length; and even combinations of alarms (audio and visual) are contemplated by the invention.

Still further, it should be understood that the devices contemplated by the invention are also intended to work with an external power source of voltage that interrupts the connection to a loud sounder device and ramps (up or down) the input voltage source to the output voltage destination device. Further yet, this application is also intended to cover conversions and upgrades to existing devices using all types of AC, DC & audio signals.

It will also be clear to those skilled in the art that the ramping effect described herein is variable, adjustable (via control) and may auto shut-off after an adjustable time period or, remain functioning until this input signal is turned off.

In further fact, the invention described herein is also intended to cover any usage of ramp up or ramp down controlling.

It will therefore be appreciated by those skilled in the art that yet further modifications could be made to the provided invention without deviating from its spirit and scope so claimed.

It will therefore be appreciated by those skilled in the art that yet further modifications could be made to the provided invention without deviating from its spirit and scope so claimed.

What is claimed is:

1. A door alarm that produces a ramping alarm signal, comprising:
a) means for inputting an alarm driver signal;
b) ramp generator means, responsive to said alarm driver signal, to provide a ramp control signal over a predetermined time period, t;
c) means responsive to said ramp control signal to provide a first predetermined output alarm signal at the beginning of time period t, ramping to a second predetermined output alarm signal at the end of time period t.

2. Apparatus as set forth in claim 1 wherein said first predetermined output alarm signal and said second predetermine output alarm signal are both audio signals.

3. Apparatus as set forth in claim 2 wherein said first predetermined output alarm signal has a volume of x decibels and said second predetermined output alarm signal has a volume of y decibels, where y is greater than x.

4. Apparatus as set forth in claim 1 wherein said ramp generator means is a linear ramp voltage circuit.

5. Apparatus as set forth in claim 1 wherein said first predetermined output alarm signal and said second predetermine output alarm signal are both visual signals.

6. A door alarm that produces a stepped alarm signal, comprising:
a) means for inputting an alarm driver signal;
b) step generator means, responsive to said alarm driver signal, to provide a stepped control signal over a predetermined time period, t;
c) means responsive to said stepped control signal to provide a first predetermined output alarm signal at the beginning of time period t, stepping to a second predetermined output alarm signal at the end of time period t.

7. Apparatus as set forth in claim 6 wherein said first predetermined output alarm signal and said second predetermine output alarm signal are both audio signals.

8. Apparatus as set forth in claim 7 wherein said first predetermined output alarm signal has a volume of x decibels and said second predetermined output alarm signal has a volume of y decibels, where y is greater than x.

9. Apparatus as set forth in claim 6 wherein said step generator means is a voltage step up circuit.

10. Apparatus as set forth in claim 6 wherein said first predetermined output alarm signal and said second predetermine output alarm signal are both visual signals.

11. A method for generating a ramping alarm signal, comprising the steps of:
(a) inputting an alarm driver signal;
(b) generating a ramp control signal, responsive to said alarm driver signal, over a predetermined time period, t;
(c) providing, in response to said ramp control signal, a first predetermined output alarm signal at the beginning of time period t, ramping to a second predetermined output alarm signal at the end of time period t.

12. A method as set forth in claim 11 wherein said first predetermined output alarm signal and said second predetermine output alarm signal are both audio signals.

13. A method as set forth in claim 12 wherein said first predetermined output alarm signal has a volume of x decibels and said second predetermined output alarm signal has a volume of y decibels, where y is greater than x.

14. A method as set forth in claim 11 further comprises the step of utilizing a linear ramp voltage circuit for generating said ramp control signal.

15. A method as set forth in claim 11 wherein said first predetermined output alarm signal and said second predetermine output alarm signal are both visual signals.

16. A method for generating a stepped alarm signal, comprising the steps of:
(a) inputting an alarm driver signal;
(b) generating a stepped control signal, responsive to said alarm driver signal, over a predetermined time period, t;
(c) providing, in response to said stepped control signal, a first predetermined output alarm signal at the beginning of time period t, stepping to a second predetermined output alarm signal at the end of time period t.

17. A method as set forth in claim 16 wherein said first predetermined output alarm signal and said second predetermine output alarm signal are both audio signals.

18. A method as set forth in claim 17 wherein said first predetermined output alarm signal has a volume of x decibels and said second predetermined output alarm signal has a volume of y decibels, where y is greater than x.

19. A method as set forth in claim 16 wherein said step of generating a stepped control signal further comprises the step of utilizing a stepped voltage circuit for generating a stepped control signal.

20. A method as set forth in claim 16 wherein said first predetermined output alarm signal and said second predetermine output alarm signal are both visual signals.
